(19) United States
(12) Patent Application Publication
(10) Pub. No.: US 2025/0123665 A1
(43) Pub. Date: Apr. 17, 2025

(54) MULTI-PORT POWER DELIVERY SYSTEM AND POWER ALLOCATION METHOD THEREOF

(71) Applicant: Delta Electronics, Inc., Taoyuan City (TW)

(72) Inventors: WEI CHIEH LIN, Taoyuan City (TW); XIN YU TSAI, Taoyuan City (TW); SHIH TING YU, Taoyuan City (TW); YI MOU LI, Taoyuan City (TW)

(73) Assignee: Delta Electronics, Inc., Taoyuan City (TW)

(21) Appl. No.: 18/629,994

(22) Filed: Apr. 9, 2024

Related U.S. Application Data
(60) Provisional application No. 63/543,520, filed on Oct. 11, 2023.

(30) Foreign Application Priority Data
Jan. 2, 2024 (CN) 202410008147.9

(51) Int. Cl. G06F 1/26; G06F 1/3206

(52) U.S. Cl. CPC G06F 1/266; G06F 1/263; G06F 1/3206

(57) ABSTRACT

A multi-port power delivery system and a power allocation method thereof are disclosed. The system comprises a first connection port, a second connection port, and a controller which is configured to monitor the average power of each connection port, and decrease the power budget of the first connection port and increase the power budget of the second connection port when the average power of the first connection port falls below a first threshold, and the average power of the second connection port exceeds a second threshold.

### CROSS REFERENCE TO RELATED APPLICATIONS

This application claims priority from U.S. Provisional Application No. 63/543,520, filed Oct. 11, 2023, the entire contents of which are incorporated herein by reference.

This application claims priority to Chinese Patent Application No. 202410008147.9, filed Jan. 2, 2024, the entire contents of which are incorporated herein by reference.

### FIELD OF DISCLOSURE

The present disclosure relates to a multi-port power delivery system and a power allocation method thereof, and in particular to a dynamic power allocation method of a multi-port USB power delivery system.

### BACKGROUND

In recent years, Universal Serial Bus (USB) connection port has been widely used in a variety of portable electronic products, including mobile phones and digital cameras. Launched in 2014, the USB Type-C represents a new generation of USB interfaces, succeeding USB Type-A and USB Type-B. The USB Type-C boosts high-speed data transmission and USB power supply capabilities. In comparison to the maximum power supply of 2.5 W for USB 2.0, 4.5 W for USB 3.0, and 7.5 W for USB BC (Battery Charging) 1.2, the USB-PD (Power Delivery) 3.0 charging specification can provide 5V, 9V, 15V, and 20V. The output voltage/current can reach up to 20V/5 A, delivering a power of 100 W, which is sufficient to meet the charging needs of notebook computers and other devices. USB-PD 3.1 takes it a step further to provide a power of 240 W, thereby catering to the charging needs of devices with higher power requirements.

When a sink device is connected to the connection port of a power delivery device, in accordance with the USB-PD specification, both the power delivery device and the sink device engage in a negotiation to determine the power requirement parameters such as voltage and current. The power delivery device will send a source capability message to the sink device via the configuration channel of the USB Type-C port. The source capability message comprises one or more options for voltage/current values. The sink device, based on the received source capability message and its own capabilities (such as the voltage and maximum current it can handle), selects one of the voltage/current option in the source capability message. It then sends a request message, containing information such as voltage and maximum current requested by the sink device, back to the power delivery device through the connection port. Upon receiving the request messages from each sink device, the power delivery device determines the power budget for each sink device, which includes the output voltage and maximum current value. The power delivery device then controls the output voltage, current, and output power of each connection port based on the power budget, and delivers power to each sink device via the respective connection port.

However, in the power supply negotiation process, the USB-PD does not address how the power delivery device should appropriately determine the power budget. Furthermore, once the power budget is set, it may no longer suitable as the charging status or other conditions of the sink devices change. There is a need for a mechanism to dynamically adjust the power budget in response to changes in power requirements, so that the unused power budget share can be reallocated to a sink device that requires more power, thereby facilitating a reduction in charging time.

### SUMMARY OF DISCLOSURE

In view of this, the present disclosure provides a multi-port power delivery system and a power allocation method thereof to properly determine the initial power budget for each sink device, and to dynamically reallocate the power budget in response to changes in power requirements of each sink device.

In one aspect, the present disclosure provides a USB multi-port power delivery system. The system comprises a first and second power converter coupled to a system power to provide power to a first or second connection port, and a controller coupled to the power converters and the connection ports. The connection ports serve as connection points for external sink devices. The controller allocates the total power budget evenly across each connection port, and negotiates the power requirement of each connection port, and sets the power budget of each connection port by classifying the power requirement of each sink device and utilizing a lookup table. Then it is monitored that when the average power of the first connection port is lower than a certain threshold and the average power of the second connection port is higher than a certain threshold, the controller prepares a downgraded or upgraded source capacity message to renegotiate the power requirement of each connection port, thereby to decrease or increase its power budget.

Another aspect of the present disclosure further provides a power allocation method applied to a USB multi-port power delivery system. The power delivery system comprises a first and second power converter coupled to a system power to provide power to a first or second connection port, and a controller coupled to the power converters and the connection ports. The method comprises: negotiating a first power requirement of the first connection port and a second power requirement of the second connection port, and determining a first power budget for the first connection port and a second power budget for the second connection port based on the first power requirement and the second power requirement; calculating a first average power of the first connection port and a second average power of the second connection port; and monitoring the difference between the first average power and the first power budget and the difference between the second average power and the second power budget, and adjusting the first power budget and the second power budget accordingly.

According to the multi-port USB power delivery system and its power allocation method provided by the present disclosure, proper allocation of the power budget can be achieved by classifying the voltage requirement of the sink device and utilizing a lookup table. And by monitoring the average power consumption of each connection port, the unused power budget share can be reallocated to a sink device that requires more power, thereby facilitating a reduction in charging time.

### BRIEF DESCRIPTION OF DRAWINGS

FIG. 1 illustrates a block diagram of a multi-port power delivery system according to an embodiment of the present disclosure.

FIG. 2 illustrates the allocation stages of a power allocation method used in a multi-port power delivery system according to an embodiment of the present disclosure.

FIG. 3 illustrates a flowchart of the first allocation stage of FIG. 2 according to the embodiment of the present disclosure.

FIG. 4 illustrates a flowchart of the second allocation stage of FIG. 2 according to the embodiment of the present disclosure.

### DETAILED DESCRIPTION

The exemplary embodiments of the present disclosure will now be elaborated upon with reference to the accompanying drawings. However, it should be noted that these exemplary embodiments can take many forms and should not be interpreted as being confined to the embodiments set forth herein. Instead, these embodiments are provided to ensure that this disclosure is comprehensive and thorough, and effectively communicates the full scope of the disclosure to those skilled in the art. The drawings are merely schematic illustrations of the disclosure, and the components depicted in the drawings are not necessarily drawn to scale. Identical reference numerals in the drawings denote identical or similar parts, hence, repeated descriptions thereof will be omitted for brevity.

In order to facilitate the description of the present disclosure, the meanings of certain terms are explained as follows. The term “current value of the connection port” refers to the amount of current supplied by the power delivery device to an external sink device via a connection port, that is, the amount of current drawn by the external sink device from the power delivery device. The term “average power of the connection port” refers to the average power supplied by the power delivery device to the external sink device via the connection port, that is, the average power drawn by the external sink device from the power delivery device. The term “power budget of the connection port” refers to the power budget set by the power delivery device for the external sink device connected to the connection port.

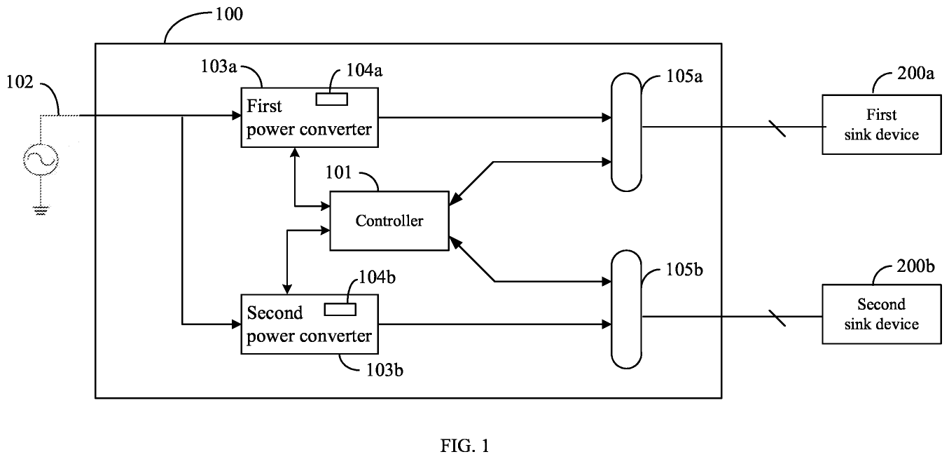

Please refer to FIG. 1, which is a block diagram of a multi-port power delivery system 100 according to an embodiment of the present disclosure. The multi-port power delivery system 100 comprises a first power converter 103a coupled between a first connection port 105a and a system power supply 102, a second power converter 103b coupled between a second connection port 105b and the system power supply 102, and a controller 101 coupled to the first power converter 103a, the second power converter 103b, the first connection port 105a, and the second connection port 105b. The first connection port 105a and the second connection port 105b are respectively used to connect to a first external sink device 200a and a second external sink device 200b. The system power supply 102 is generally an AC power supply, but technically it can also be a DC power supply. The first power converter 103a and the second power converter 103b convert the system power into direct current, and respectively supplies power to the first connection port 105a and the second connection port 105b under the control of the controller 101.

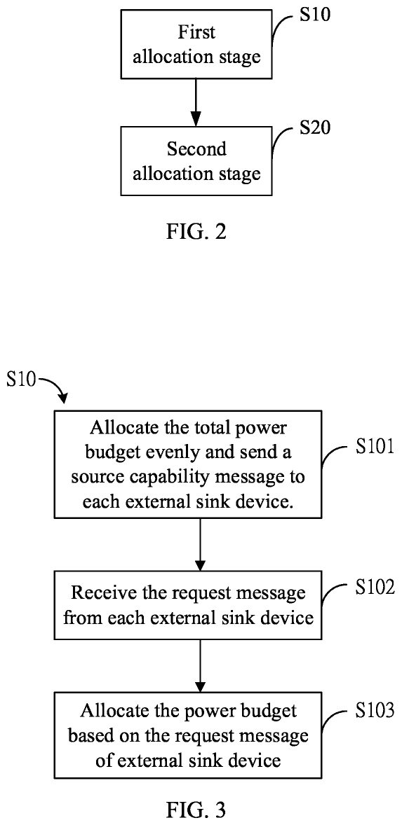

Please refer to FIG. 2, which illustrates the allocation stages of a power allocation method used in a multi-port power delivery system according to an embodiment of the present disclosure. The power allocation method comprises two stages: a first allocation stage S10 and a second allocation stage S20. The first allocation stage S10 performs power budget allocation by classifying a voltage requirement of each external sink device and utilizing a lookup table. In the second allocation stage S20, by monitoring the power consumption of each connection port, when it is observed that an unused power budget share of a sink device can be transferred to another sink devices that requires more power, the power budget will be reallocated by decreasing or increasing the power budget of each port. This reallocation involves either a decrease or increase in the power budget of each port, thereby fully utilizing the overall power supply capability of the multi-port power delivery system and accelerating the charging process of the sink device that requires more power. The implementation details of the above two stages are elaborated in the following paragraphs.

Please refer to FIG. 3, which illustrates a flowchart of the first allocation stage of FIG. 2 according to the embodiment of the present disclosure. The first distribution stage S10 of the multi-port power delivery system 100 comprises the following steps:

Step S101: The controller 101 allocates the total power budget evenly across each connection port. It then sends a source capability message to each of the first external sink device 200a and the second external sink device 200b via the first connection port 105a and the second connection port 105b, respectively. The source capability message includes data on available voltage/current values, thereby informing the first external sink device 200a and the second external sink device 200b of the source capability of the multi-port power delivery system 100.

Taking the maximum output power of the multi-port power delivery system 100 as 66 W as an example. That implies that 66 W is the highest power budget that the multi-port power delivery system 100 can provide. Since the power requirements of the first external sink device 200a and the second external sink device 200b are unknown in the first allocation stage, the controller 101 of the multi-port power delivery system 100 initially divides the 66 W evenly into two preliminary power budgets. Consequently, the power budget for both the first connection port 105a and the second connection port 105b is set at 33 W. Based on these power budgets, the controller 101 sends a source capability message to respective external sink device via respective connection port. The source capability message includes one or more options for voltage/current values that are close to the power budget, such as 20V/1.5 A, 15V/2 A, etc., thereby demonstrating the source capability of the multi-port power delivery system 100.

Step S102: The controller 101 receives the request messages from the external sink devices through their respective connection ports. Through the request message, the external sink device replies the voltage requirement and the maximum current that it can handle to the multi-port power delivery system 100.

Step S103: The controller 101 allocates the power budget for each connection port, that is, the power budget for each external sink device, based on the request message of each external sink device. According to an embodiment of the present disclosure, the controller 101 categorizes the external sink devices based on their voltage requirements. For instance, the sink devices that require 5V, 9V, 15V, and 20V are classified as Type 1, Type 2, Type 3, and Type 4 respectively, as depicted in Table 1. Noted that typically, among the present mobile devices, the voltage requirement for mobile phones is 5V or 9V, for tablets is 9V or 15V, and for notebook computers is 15V or 20V.

TABLE 1

| Type | Voltage requirement | Power requirement range |
|---|---|---|
| Type 1 | 5 V | 7.5~15 W |
| Type 2 | 9 V | 15 W~27 W |
| Type 3 | 15 V | 27 W~45 W |
| Type 4 | 20 V | 45 W~60 W |

Based on practical experiences, a higher the voltage requirement of the sink device typically indicates a greater power requirement. The “power requirement range” column in Table 1 illustrates the practical approximate power requirement range, spanning from 7.5 W to 60 W.

Since the power requirement is positively correlated with the voltage requirement, the controller 101, according to an embodiment of the present disclosure, uses a lookup table, Table 2 is an example, to determine the power budget of each connection port based on the type of each external sink device.

Upon determining the power budget and voltage for each connection port, the controller 101 regulates the output voltage and current of both the first power converter 103a and the second power converter 103b. For instance, if the voltage requirements of external sink devices are 5V and 15V respectively, these sink devices are classified into Type 1 and Type 3 respectively, as per Table 1. Next, by looking up Table 2, the power budgets of the first connection port 105a and the second connection port 105b are set as 15 W and 51 W, respectively. Subsequently, the controller 101 will regulate the output voltages of the first power converter 103a and the second power converter 103b to be 5V and 15V respectively and control the output power within the allocated power budget.

TABLE 2

| Type | | Power budget | |
|---|---|---|---|
| First | Second | First | Second |
| connection port | connection port | connection port | connection port |
| Type 1 | Type 1 | 33 W | 33 W |
| Type 2 | Type 3 | 15 W | 51 W |
| Type 2 | Type 4 | 22 W | 44 W |
| Type 3 | Type 3 | 33 W | 33 W |
| Type 3 | Type 4 | 33 W | 33 W |
| Type 4 | Type 4 | 33 W | 33 W |

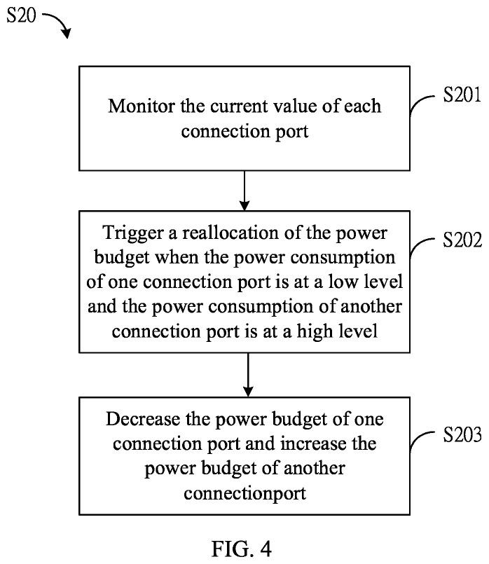

Please refer to FIG. 4, which illustrates a flowchart of the second allocation stage of FIG. 2 according to the embodiment of the present disclosure. The second allocation stage S20 of the multi-port power delivery system 100 comprises the following steps.

Step S201: Monitor the current value of each connection port. In the present disclosure, the first power converter 103a comprises a first current sensor 104a for measuring the current value drawn by the first connection port 105a, and the second power converter 103b comprises a second current sensor 104b for measuring the current value drawn by the second connection port 105b.

Step S202: The controller 101 triggers a reallocation of the power budget when the power consumption of one connection port is at a low level and the power consumption of another connection port is at a high level. That is, when the controller 101 detects that the power consumption of a connection port is lower than a predetermined value relative to its power budget, and the power consumption of another connection port is nearing its power budget, the controller 101 will trigger a reallocation of the power budget for each connection port.

More specifically, in this step, the controller 101 periodically monitors the average power of each connection port. Here, the so-called periodic execution could be performed periodically or at a scheduled time by the controller 101. According to an embodiment of the present disclosure, the controller 101 monitors the difference between the average power of each connection port and its power budget. For example, if the average power of the first connection port 105a is less than a first threshold, and the average power of 105b of the second connection port 105a exceeds a second threshold, it regards that the power consumption of the first external sink device 200a connected to the first connection port 105a is at a low level, indicating a lower power requirement. Conversely, the power consumption of the second external sink device 200b connected in the second connection port 105b is relatively high, suggesting a potential need for additional power. Therefore, the controller 101 proactively triggers a reallocation of the power budget, enabling the reallocation of unused power budget shares to a sink device that requires more power.

The first threshold is a value less than the power budget of the first connection port 105a. This cloud be a value derived by subtracting a certain amount (for example, 20 W) from the power budget of the first connection port 105a, or a value obtained by multiplying the power budget of the first connection port 105a by a certain ratio (for example, 20%). Similarly, the second threshold is also a value less than the power budget of the second connection port 105b. This could be a value derived by subtracting a certain amount (for example, 10 W) from the power budget of the second connection port 105b, or a value obtained by multiplying the power budget of the second connection port 105b by a certain ratio (for example, 80%). It is understandable that the method of subtraction or multiplication, or other methods for setting the first/second thresholds for indicating whether the average power consumption of the connection port is at a low or high level, or a combination of these methods are all applicable to present disclosure. For instance, the first threshold cloud be set to the power budget of the first connection port 105a minus 20 W, and the second threshold could be set to the power budget of the second connection port 105b multiplied by 80%.

Taking USB Type-C as an example, when the controller 101 detects that the power consumptions have reached both high and low levels. For example, if the power consumption of the first connection port 105a is at a low level and the power consumption of the second connection port 105b is at a high level, the controller 101 prepares an updated version of the source capability message for each connection port, wherein the voltage/current options in the source capability message for the first connection port 105a are downgraded, while the voltage/current options in the source capability message for the second connection port 105b are upgraded. These source capability messages are then sent to the external sink devices via respective connection ports for renegotiation of the voltage/current requirements with each external sink device.

Regarding the average power, in one embodiment of the present disclosure, the controller 101 obtains the current values measured by the current sensor 104a and the current sensor 104b, and performs an average operation to compute the average current value, which in turn allows for the calculation of the average power consumption of each connection port. The present disclosure employs a running average method to calculate the average current value. However, various other methods for calculating averages, such as averaging the most recent N data points, can also be utilized in the present disclosure. By using the calculated average current value and the voltage value given in the power budget, the average power can be derived.

Step S203: Decrease the power budget of one connection port and increase the power budget of another connection port. Following the example in step 202, the controller 101 sends the downgraded source capability message to the first external sink device 200a via the first connection port 105a, and sends the upgraded source capability message to the second external device via the second connection port 105b. Once the request message from the first external sink device 200a indicates acceptance of the reduced voltage or current, and the request message from the second external sink device 200b indicates acceptance of the increased voltage or current, the controller 101 then reduces the power budget of the first connection port 105a by controlling the first power converter 103a to operate at a lower voltage or current, and increases the power budget of the second connection port 105b by controlling the second power converter 103b to operate at a higher voltage or current. By this way, the unused power budget share is reallocated to a sink device that requires more power, thereby facilitating a reduction in charging time.

In summary, a multi-port USB power delivery system and its power allocation method, as provided by the present disclosure, can effectively allocate the power budget by classifying the voltage requirement of the sink device and utilizing a lookup table. By monitoring the average power consumption of each connection port, the unused power budget share can be reallocated to a sink device that requires more power, thereby facilitating a reduction in charging time.

The aforementioned details represent only specific implementations of the present disclosure. However, the protection scope of the present disclosure is not limited thereto. Any modifications or replacements that can be easily devised by those skilled in the art within the technical scope of the present disclosure should all fall within the protection scope of the present disclosure. Consequently, the protection scope of the present disclosure should be defined by the protection scope of the appended claims.

What is claimed is:

1. A multi-port power delivery system for allocating a system power for deliverying power to a plurality of external sink devices, comprising:
a first power converter coupled between a first connection port and the system power;
a second power converter coupled between a second connection port and the system power; and
a controller coupled to the first power converter, the second power converter, the first connection port and the second connection port, the controller configured to perform following features:
(a) negotiate a first power requirement of the first connection port and a second power requirement of the second connection port, and determine a first power budget of the first connection port and a second power budget of the second connection port;
(b) calculate a first average power of the first connection port and a second average power of the second connection port; and
(c) monitor the difference between the first average power and the first power budget and the difference between the second average power and the second power budget, and adjust the first power budget and the second power budget accordingly.

2. The multi-port power delivery system according to claim 1, wherein the multi-port power delivery system complies with a USB Power Delivery specification.

3. The multi-port power delivery system according to claim 1, wherein the first connection port and the second connection port are USB Type-C connection ports.

4. The multi-port power delivery system according to claim 1, wherein in the feature (a), the controller is further configured to:
(a1) classify the first power requirement as a first type based on a first voltage requirement in the first power requirement;
(a2) classify the second power requirement as a second type based on a second voltage requirement in the second power requirement; and
(a3) determine the first power budget and the second power budget based on the first type and the second type using a lookup table.

5. The multi-port power delivery system according to claim 1, wherein
the first power converter comprises a first current sensor for measuring a first current value of the first connection port;
the second power converter comprises a second current sensor for measuring a second current value of the second connection port; and
in the feature (b), the controller is further configured to:
(b1) calculate the first average power based on a first output voltage of the first power budget and the first current value; and
(b2) calculate the second average power based on the second output voltage of the second power budget and the second current value.

6. The multi-port power delivery system according to claim 1, wherein in the feature (c), the controller is further configured to:
negotiate the power requirement with the first connection port and the second connection port to reduce the first power budget and increase the second power budget when the first average power is less than a first threshold and the second average power is greater than a second threshold.

7. The multi-port power delivery system according to claim 6, wherein the first threshold is smaller than the first power budget and the second threshold is smaller than the second power budget.

8. A power allocation method applied to a multi-port power delivery system for allocating system power to a plurality of external sink devices, comprising the steps of:
(a) negotiating, by a controller, a first power requirement of a first connection port and a second power requirement of a second connection port, and determining a first power budget for the first connection port and a second power budget for the second connection port based on the first power requirement and the second power requirement;
(b) calculating, by the controller, a first average power of the first connection port and a second average power of the second connection port; and
(c) monitoring, by the controller, the difference between the first average power and the first power budget and the difference between the second average power and the second power budget, and adjusting the first power budget and the second power budget accordingly.

9. The power allocation method according to claim 8, wherein the multi-port power delivery system complies with a USB Power Delivery specification.

10. The power allocation method according to claim 8, wherein the first connection port and the second connection port are USB Type-C connection ports.

11. The power allocation method according to claim 8, wherein the step (a) further comprises the following steps:
(a1) classifying, by the controller, the first power requirement as a first type based on a first voltage requirement in the first power requirement;
(a2) classifying, by the controller, the second power requirement as a second type based on a second voltage requirement in the second power requirement; and
(a3) determining, by the controller, the first power budget and the second power budget based on the first type and the second type using a lookup table.

12. The power allocation method according to claim 8, wherein the step (b) further comprises the following steps:
(b1) measuring, by a first current sensor, a first current value of the first connection port;
(b2) measuring, by a second current sensor, a second current value of the second connection port;
(b3) calculating, by the controller, a first average current value based on the first current value, and a second average current value based on the second current value;
(b4) calculating, by the controller, the first average power based on a first output voltage of the first power budget and the first average current value; and
(b5) calculating, by the controller, the second average power based on a second output voltage of the second power budget and the second average current value.

13. The power allocation method according to claim 8, wherein the step (c) further comprises the following step:
negotiating, by the controller, the power requirement of the first connection port and the second connection port to reduce the first power budget and increase the second power budget when the first average power is less than a first threshold and the second average power is greater than a second threshold.

14. The power allocation method of claim 13, wherein the first threshold is smaller than the first power budget and the second threshold is smaller than the second power budget.
